(19) United States
(12) Patent Application Publication
(10) Pub. No.: US 2025/0313448 A1
(43) Pub. Date: Oct. 9, 2025

(54) DROP-IN JOCKEY BOX SYSTEM

(71) Applicant: Daniel S. Ryan, Austin, TX (US)

(72) Inventor: Daniel S. Ryan, Austin, TX (US)

(21) Appl. No.: 19/170,209

(22) Filed: Apr. 4, 2025

Related U.S. Application Data
(60) Provisional application No. 63/575,258, filed on Apr. 5, 2024.

(51) Int. Cl. B67D 1/08; B65D 81/38

(52) U.S. Cl. CPC B67D 1/0857; B65D 81/3813; B67D 2210/00044; B67D 2210/00128

(57) ABSTRACT

A jockey box system used with a cooler having a thermal spacer with a front wall and two tapered side walls. The said thermal spacer is positioned on an upper edge of a body of the cooler and the thermal spacer has one or more inlets and one or more outlets formed on the front wall and a cooling system mounted below the thermal spacer for cooling contents of the cooler. The jockey box system is configured to be installed and removed from the cooler without modifying the cooler.

### CLAIM OF PRIORITY

This application claims priority from Provisional Patent Application Ser. No. 63/575,258 filed on Apr. 5, 2024, the entirety of which is incorporated by reference herein.

### BACKGROUND OF THE DISCLOSURE

The present disclosure relates to portable draft beverage systems. It finds particular application in providing a drop-in solution that converts a cooler into a jockey box without taking away the cooler's ability to function as a standard cooler.

A jockey box allows a user to have a portable draft beverage system, often used for beer. Traditional jockey boxes use a cooler with holes drilled into it for corresponding inlets and outlets. A draft beverage may enter an inlet and run through a cooling segment of the jockey box. This cooling segment allows the draft beverage to be cooled by the contents of the jockey box, which often includes ice. After the cooling segment, the draft beverage may exit the outlet to be poured into the user's drinkware.

The traditional jockey box requires dedication of a cooler to be used as only a jockey box. This often requires a person to purchase two coolers, one for use as a jockey box and one for use as a traditional cooler. This requires additional storage and expense.

Thus, there is a need for a convenient way of converting a traditional cooler to a jockey box without destroying the cooler's ability to be used as a traditional cooler.

### SUMMARY OF THE DISCLOSURE

The present disclosure sets forth a drop-in jockey box system that allows the user to convert an ordinary cooler into a jockey box without significant alterations to the cooler. The system may be removed from the traditional cooler and allows the cooler to still function as a standard cooler (i.e. hold ice and cans/bottles).

One aspect of the disclosure is the drop-in jockey box system preferably has one or more inputs and corresponding outputs, a cooling section connecting each input and output, and a thermal spacer. The system may be connected to a cooler such that the cooling section is inside the cooler. The thermal spacer may rest on a lip of the cooler and allow the cooler's lid to rest on top of the thermal spacer. This creates a thermal divider between the cooler's inside and contents from the outside. In some embodiments the cooling section may be a series of coolers while in other embodiments the cooling section may be a plater cooler.

Another aspect of the disclosure is a drop in jockey system as a wedge which allows the cooler to be sealed while in the open position.

Another aspect of the disclosure is a drop in system which has beer shank holes which eliminates the need to drill holes into the cooler itself.

Yet another aspect of the disclosure is a drop-in jockey box system configured to be placed in an associated cooler, having a thermal spacer having at least one inlet and at least one outlet, formed in said thermal spacer and at least one cooling section mounted adjacent the thermal spacer.

In accordance with another aspect of the disclosure, a jockey box system used with a cooler includes a thermal spacer having a front wall and two tapered side walls. The thermal spacer is positioned on an upper edge of a body of the cooler and the thermal spacer has one or more inlets and one or more outlets formed on the front wall and a cooling system mounted below said thermal spacer for cooling contents of the cooler.

Still another aspect of the disclosure are internal coils which sit on a metal chassis for both structural support and durability.

Still other aspects of the disclosure will become apparent upon a reading and understanding of the following detailed description.

### BRIEF DESCRIPTION OF THE DRAWINGS

FIG. 1 is a side elevational view of the drop-in jockey box system of the present disclosure.

FIG. 2 is a top plan view of the drop-in jockey box system.

FIG. 3 is a front elevational view of the drop-in jockey box system.

FIG. 4 is a front elevational view of the drop-in jockey box system placed in a cooler.

FIG. 5 is a perspective view of the drop-in jockey box system placed in a cooler.

FIG. 6 is a perspective view of the drop-in jockey box frame.

FIG. 7 is a perspective view of the thermal spacer assembly.

FIG. 8 is a perspective view of the front wall of the thermal spacer assembly.

FIG. 9 is a perspective view of the left side wall of the thermal spacer assembly.

FIG. 10 is a perspective view of the right side wall of the thermal spacer assembly.

### DETAILED DESCRIPTION OF THE DISCLOSURE

Hereinafter, exemplary embodiments of the present disclosure are described in detail with reference to the accompanying drawings. Detailed description of well-known functions and structures incorporated herein may be omitted to avoid obscuring the subject matter of the present disclosure.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used herein, the terms about, generally, and substantially are intended to encompass structural or numerical modifications which do not significantly affect the purpose of the element or number modified by such term.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredient/steps, along with any impurities that might result therefrom, and excludes other ingredients/steps.

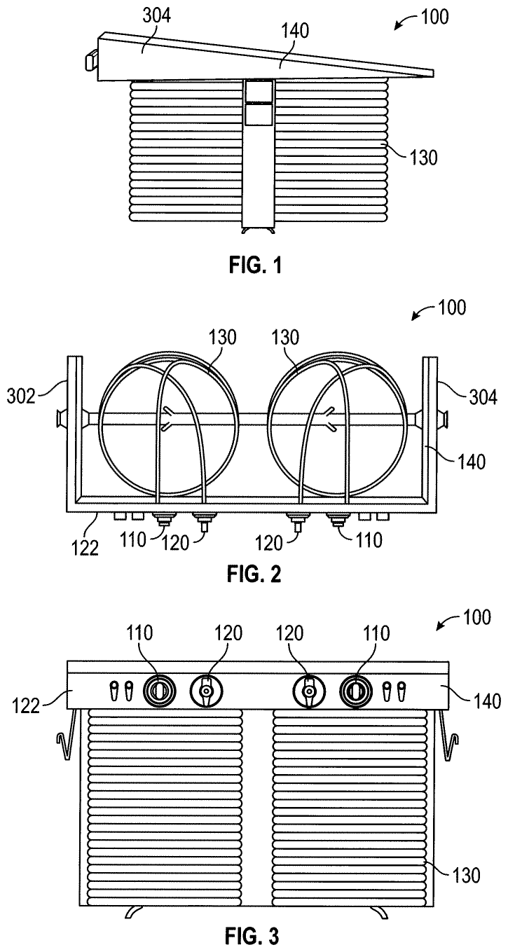

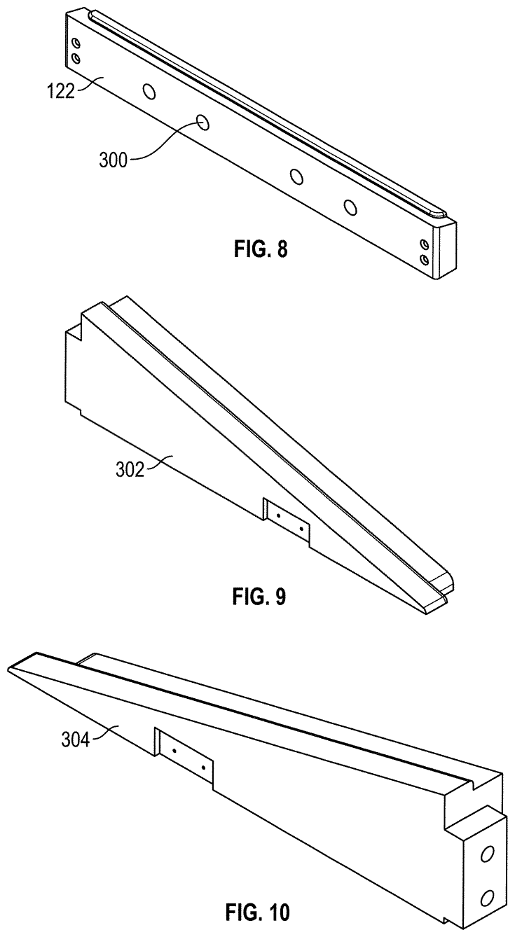

The present disclosure relates to jockey box systems and converting a cooler into a jockey box without significantly altering the cooler. FIGS. 1-10 illustrate a preferred embodiment of the disclosure.

Referring to FIG. 1, a side elevational view of a drop-in jockey box system 100 is shown. A cooling section 130 can be seen below a thermal spacer 140. FIG. 2 is a top plan view of the drop in jockey box system 100. The thermal spacer 140 can again be seen with inlets 110 and outlets 120 mounted to front wall 122 of the thermal spacer 140. Two cooling sections 130 can be seen connecting corresponding inlets 110 and outlets 120. FIG. 3 is a front view of the drop-in jockey box system 100. The two cooling sections 130 can be seen on either side of the drop-in jockey box system 100. Corresponding inlets 110 and outlets 120 can also be seen mounted on either side of the thermal spacer 140.

Referring to FIGS. 1-3 together it can be seen that a user may connect a beverage source such as a keg to an inlet 110 so that the beverage may then flow through a cooling section 130 and out an outlet 120. In the shown embodiment there are two sets of inlets 110, outlets 120, and cooling sections 130. In other embodiments there may be only one inlet 110, one outlet 120, which are connected by one cooling section 130. In certain embodiments there may be more than two sets of inlets 110, outlets 120, and cooling sections 130. In the shown embodiment the cooling section 130 is preferably formed by a series of coils, while in other embodiments the cooling section 130 may be formed by a cold plate.

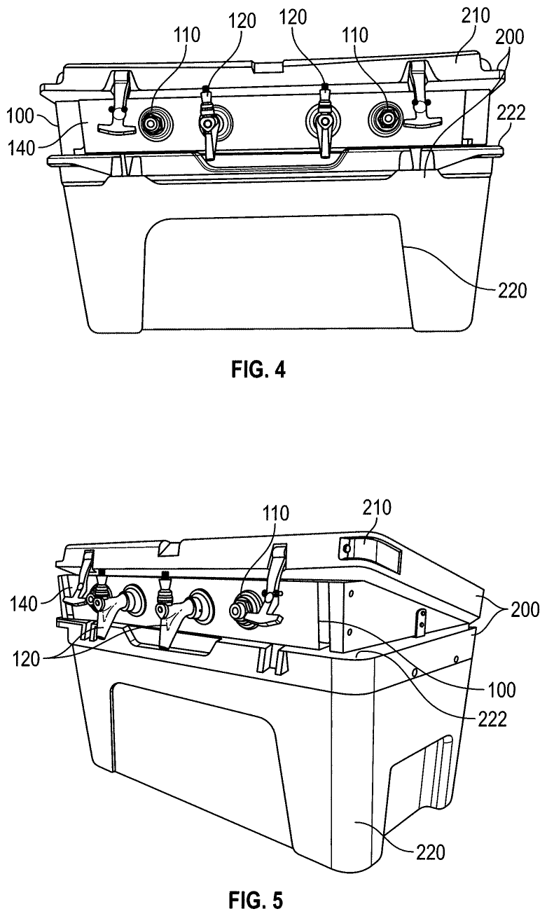

FIG. 4 and FIG. 5 show a front elevational view and a perspective view of the drop-in jockey box system 100 mounted in a cooler 200. The drop in system preferably formed of reinforced plastic or steel. However, other suitable materials are contemplated by the disclosure.

The cooler 200 can be seen with a body 220 and a lid 210. The thermal spacer 140 can be seen with mounted inlets 110 and outlets 120. The thermal spacer 140 rests on a cooler lip or edge 222 at an upper end of the body and the cooler's lid 210 rests on top of the thermal spacer. This creates a thermal barrier between the cooler's 200 contents and the outside of the cooler.

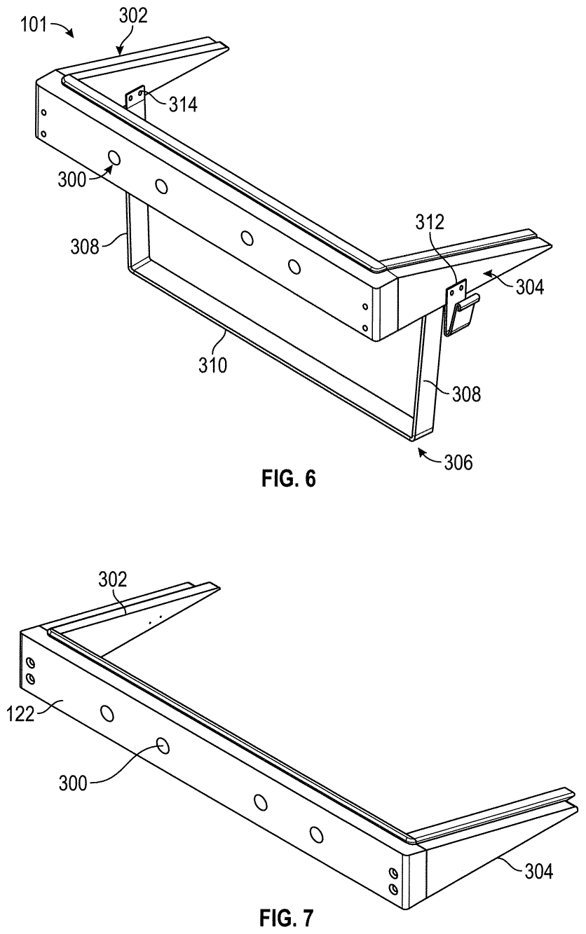

Referring now to FIGS. 6-10, components of the dop-in jockey box frame 101 are shown. A plurality of openings 300 are shown in front wall 122 which are used for inlets 110 and outlets 120. Left and right side walls 302, 304 are tapered so that the cooler lid 210 can be partially closed while still exposing the box 100 and keeping the internal compartment of the cooler sealed. An extension member 306 with parallel vertical portions 308 and a horizontal portion 310 perpendicular to portions 308 positions and anchors the box 100 with the cooler. Clips 312, 314 can be welded or otherwise secured to side walls 302, 304 to secure the box to side walls of the cooler.

The present disclosure shows a thermal spacer with holes for two inlets and two outlets. However, other size coolers are contemplated by the disclosure, such as spacers with one inlet and one outlet, three inlets and three outlets, etc.

During use, a user may open the lid of the cooler 200 and set the drop-in jockey box system 100 in the cooler such that the thermal spacer 140 rests on the cooler lip 222 and the cooling section 130 is positioned inside the cooler 200. The user may then place ice inside the cooler 200 and around the cooling section 130 creating a cold environment inside the cooler 200. The user may then close the lid 210 of the cooler 200 creating a thermal barrier between the inside of the cooler 200 and the outside. The user may then attach a beverage source such as a keg to the inlet 110. The beverage may then move from the inlet 110 and through the cooling section 130 inside the cooler 200. While the beverage moves through the cooling section 130 it drops in temperature as a result of the cold environment inside the cooler 200. From the cooling section 130 the beverage may then exit the drop-in jockey box system 100 through the outlet 120.

The disclosure has been described with reference to several embodiments. Obviously, modifications and alterations will occur to others upon a reading and understanding of the specification. It is intended to include all such modifications and alterations insofar as they come within the scope of the description and the appended claims or the equivalents thereof.

1. A drop-in jockey box system configured to be placed in an associated cooler, comprising:
a thermal spacer;
at least one inlet and at least one outlet formed in said thermal spacer; and
at least one cooling section mounted adjacent said thermal spacer.

2. The drop-in jockey box system of claim 1, wherein the at least one cooling section connects the at least one inlet to the at least one outlet.

3. The drop-in jockey box system of claim 2, wherein a beverage may flow into the cooler via the inlet, through the cooling section, and out of the cooler via the outlet.

4. The drop-in jockey box system of claim 2, wherein the inlet and outlet are formed on a front wall of the thermal spacer.

5. The drop-in jockey box system of claim 1, wherein the system is configured to fit into the cooler and to be removed from the cooler without modifications to the cooler.

6. The drop-in jockey box system of claim 5, wherein the thermal spacer is positioned on a cooler lip formed on an upper portion of a body of said cooler.

7. The drop-in jockey box system of claim 6, wherein a cooler lid is positioned onto the thermal spacer.

8. The drop-in jockey box system of claim 7, wherein the thermal spacer fills a gap formed between the cooler body and the cooler lid; thereby creating a thermal barrier between contents of the cooler and outside of the cooler.

9. The drop-in jockey box system of claim 1, wherein the cooling section is formed by a series of coils.

10. The drop-in jockey box system of claim 1, wherein the cooling section is formed by a cold plate.

11. The drop-in jockey box system of claim 1, wherein said thermal spacer comprises a front wall and first and second side walls which are tapered to accommodate partial closing of a lid of said cooler.

12. The drop-in box system of claim 11, further comprising an extension member mounted to said thermal spacer to anchor said drop-in jockey box system in said cooler.

13. A jockey box system used with a cooler, comprising:
a thermal spacer comprising a front wall and two tapered side walls, wherein said thermal spacer is positioned on an upper edge of a body of said cooler;
said thermal spacer comprises one or more inlets and one or more outlets formed on said front wall; and
a cooling system mounted below said thermal spacer for cooling contents of said cooler.

14. The jockey box system of claim 13, wherein said system is configured to be installed and removed from the cooler without modifying said cooler.
